(19) United States
(12) Patent Application Publication
(10) Pub. No.: US 2024/0144253 A1
(43) Pub. Date: May 2, 2024

(54) CONTROL METHOD, SERVER, AND RECORDING MEDIUM

(71) Applicant: Panasonic Intellectual Property Corporation of America, Torrance, CA (US)

(72) Inventor: Naohisa NISHIDA, Kanagawa (JP)

(21) Appl. No.: 18/411,696

(22) Filed: Jan. 12, 2024

Related U.S. Application Data
(63) Continuation of application No. PCT/JP2022/028795, filed on Jul. 26, 2022.
(60) Provisional application No. 63/229,765, filed on Aug. 5, 2021.

(51) Int. Cl. G06Q 20/38; G06Q 20/36; H04L 9/00

(52) U.S. Cl. CPC G06Q 20/382; G06Q 20/36; G06Q 20/389; H04L 9/50

(57) ABSTRACT

A control method according to the present disclosure includes: determining the presence or absence of transaction data related to a first target that has not been used for a predetermined period among targets each being transaction data stored in a blockchain; and deleting the transaction data related to the first target from the blockchain based on a determination result indicating that the transaction data related to the first target is present.

### CROSS REFERENCE TO RELATED APPLICATIONS

This is a continuation application of PCT International Application No. PCT/JP2022/028795 filed on Jul. 26, 2022, designating the United States of America, which is based on and claims priority of U.S. Provisional Patent Application No. 63/229,765 filed on Aug. 5, 2021. The entire disclosures of the above-identified applications, including the specifications, drawings and claims are incorporated herein by reference in their entirety.

### FIELD

The present disclosure relates to control methods, servers, and recording media.

### BACKGROUND

A virtual wallet for managing cryptoassets such as coins that are traded using the blockchain technology is known as a wallet.

For example, Patent Literature (PTL) 1 discloses a system capable of securely transmitting information for use of the wallet while ensuring transparency using a transaction on a blockchain on which a smart contract can run.

### CITATION LIST

### Patent Literature

PTL 1: Japanese Unexamined Patent Application Publication No. 2020-025232

### SUMMARY

### Technical Problem

Real banks or the like take measures such as disabling accounts that have not been accessed for several years and charging a commission to maintain accounts, for example.

However, the blockchain used in PTL 1, for example, does not include such a system, meaning that even a wallet and a smart contract that have not been used for a long period of time will remain permanently on the blockchain.

This results in the problem of an enlarged blockchain, leading to increased memory consumption and increased cost for operating the blockchain, for example.

The present disclosure is conceived in view of the above-described circumstances and has an object to provide a control method, etc., in which blockchain enlargement can be minimized.

### Solution to Problem

In order to achieve the aforementioned object, a control method according to one aspect of the present disclosure includes: determining presence or absence of transaction data related to a first target that has not been used for a predetermined period among targets each being transaction data stored in a blockchain; and deleting the transaction data related to the first target from the blockchain based on a determination result indicating that the transaction data related to the first target is present.

Note that these general and specific aspects may be implemented using a system, a method, an integrated circuit, a computer program, or a computer-readable recording medium such as a compact disc read-only memory (CD-ROM), or any combination of systems, methods, integrated circuits, computer programs, and recording media.

### Advantageous Effects

With the control method, etc., according to the present disclosure, blockchain enlargement can be minimized.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a schematic block diagram illustrating the configuration of a control system according to an exemplary embodiment.

FIG. 2 is an explanatory diagram illustrating the data structure of a blockchain according to an exemplary embodiment.

FIG. 3 is an explanatory diagram illustrating the data structure of a block in a blockchain according to an exemplary embodiment.

FIG. 4 is a diagram illustrating one example of ledger information in a plurality of blocks included in a blockchain according to an exemplary embodiment.

FIG. 5 is a diagram illustrating one example of an account list included in a block according to an exemplary embodiment.

FIG. 6 is a diagram illustrating one example of a Tx data list included in a block according to an exemplary embodiment.

FIG. 7 is a schematic block diagram illustrating the configuration of a node according to an exemplary embodiment.

FIG. 8 is a flowchart illustrating the broad outline of processing according to an exemplary embodiment in which a BC node deletes entity data from a blockchain.

FIG. 9 is a flowchart illustrating example processing for a blockchain wallet according to an exemplary embodiment.

FIG. 10 is a diagram illustrating an example in which an account list is deleted in example processing for a blockchain wallet according to an exemplary embodiment.

FIG. 11 is a diagram illustrating an example in which a Tx data list is deleted in example processing for a blockchain wallet according to an exemplary embodiment.

FIG. 12 is a flowchart illustrating example processing 1 for a smart contract according to an exemplary embodiment.

FIG. 13 is a diagram illustrating an example in which an account list is deleted in example processing 1 for a smart contract according to an exemplary embodiment.

FIG. 14 is a diagram illustrating an example in which a Tx data list is deleted in example processing 1 for a smart contract according to an exemplary embodiment.

FIG. 15 is a flowchart illustrating example processing 2 for a smart contract according to an exemplary embodiment.

FIG. 16 is a diagram illustrating one example of information included in delete request transaction data according to example processing 2 for a smart contract according to an exemplary embodiment.

FIG. 17 is a diagram illustrating one example of information included in deletion rule setting transaction data.

FIG. 18 is an explanatory diagram illustrating the data structure of a blockchain according to another exemplary embodiment.

FIG. 19 is an explanatory diagram illustrating the data structure of a block in a blockchain according to another exemplary embodiment.

### DESCRIPTION OF EMBODIMENT

A control method according to the first aspect of the present disclosure includes: determining presence or absence of transaction data related to a first target that has not been used for a predetermined period among targets each being transaction data stored in a blockchain; and deleting the transaction data related to the first target from the blockchain based on a determination result indicating that the transaction data related to the first target is present.

With this, it is possible to provide a control method in which blockchain enlargement can be minimized.

More specifically, transaction data related to the first target that is at least one of a blockchain wallet, a smart contract, and specific transaction data including entity data other than a transaction history that have not been used for a long period of time is deleted from a plurality of blocks in a blockchain.

Thus, because the integrity of the blockchain remains verifiable using the headers of the plurality of blocks in the blockchain, deletion of transaction data that is the body data of transaction information not in use is possible without being regarded as tampering.

In this manner, data on the blockchain that has not been used for a predetermined period can be deleted, and thus blockchain enlargement can be minimized.

The control method according to the second aspect of the present disclosure is the control method according to the first aspect further including: obtaining, from one of the plurality of nodes, delete request transaction data that is transaction data created by a user who has created the first target and indicates that the first target is to be deleted. When the delete request transaction data is recorded into the blockchain, the transaction data related to the first target is deleted.

With this, obtainment of the delete request transaction data created by a user who created the first target that has not been used for the predetermined period can be a trigger to delete the transaction data related to the first target from the plurality of blocks in the blockchain.

Furthermore, the control method according to the third aspect of the present disclosure is the control method according to the first aspect in which when transaction data including an address indicating a target that is at least one of transaction data for making a monetary transaction, transaction data for deploying a smart contract, transaction data for calling up a smart contract, and other transaction data has not been obtained for the predetermined period, the target is regarded as the first target, and transaction data related to the target is deleted.

With this, a failure to obtain the transaction data indicating the address indicating the first target for the predetermined period can be a trigger to delete the transaction data related to the first target from the plurality of blocks in the blockchain.

Furthermore, the control method according to the fourth aspect of the present disclosure is the control method according to any one of the first aspect to the third aspect in which when a blockchain wallet having a zero remaining amount of coins is found, the blockchain wallet is regarded as the first target, and transaction data related to the blockchain wallet is deleted.

In this manner, regarding the blockchain wallet, when the remaining amount of coins to be exchanged in the blockchain wallet reaches zero, the transaction data related to the blockchain wallet may be deleted from the plurality of blocks in the blockchain. Specifically, when the blockchain wallet is of the disposable type, the blockchain wallet will not be used after the remaining amount of coins therein reaches zero; therefore, the first target may be set to this blockchain wallet and the transaction data related to the first target may be deleted. Thus, data on the blockchain that has not been used for the predetermined period can be deleted, and blockchain enlargement can be minimized accordingly.

Furthermore, the control method according to the fifth aspect of the present disclosure is the control method according to any one of the first aspect to the fourth aspect in which a header of metadata and transaction data for a plurality of transactions are stored in each of a plurality of blocks included in the blockchain, the metadata including a hash value of an immediately preceding block and a transaction tree in which the transaction data for the plurality of transactions included in the block is summarized in a Merkle tree, the transaction data for the plurality of transactions being body data, an account list is further stored in the header, the account list describing monetary transaction information related to an account provided when a blockchain wallet is created, and when the first target is a first blockchain wallet, the deleting of the transaction data related to the first target includes: deleting, among transaction data including the first blockchain wallet as a transmission source or a transmission destination, first transaction data including a second blockchain wallet as a transmission source or a transmission destination, the second blockchain wallet being different from the first blockchain wallet and having been deleted; and deleting information of the first blockchain wallet from one or more account lists describing the information of the first blockchain wallet among a plurality of account lists included in the plurality of blocks.

Thus, because the integrity of the blockchain can remain verifiable using the headers of the plurality of blocks in the blockchain, deletion of transaction data in the first blockchain wallet that is the first target is possible without being regarded as tampering.

Furthermore, the control method according to the sixth aspect of the present disclosure is the control method according to any one of the first aspect to the fifth aspect in which a world state indicating a state of an entire network of the blockchain is further stored in an in-memory database of each of the plurality of nodes, and when the first target is the first blockchain wallet, the method further includes: before the deleting of the transaction data related to the first target, deleting information of the first blockchain wallet that is included in the world state.

Thus, because the integrity of the blockchain can remain verifiable using the headers of the plurality of blocks in the blockchain, deletion of transaction data in the first blockchain wallet that is the first target is possible without being regarded as tampering.

Here, the control method according to the seventh aspect of the present disclosure is the control method according to the sixth aspect in which the information of the first blockchain wallet that is included in the world state is information of a sender side and a recipient side that have used the first blockchain wallet.

Furthermore, the control method according to the eighth aspect of the present disclosure is the control method according to any one of the first aspect to the seventh aspect in which the deleting of the transaction data related to the first target includes: when the first target is a first smart contract, deleting first transaction data for deploying the first smart contract.

With this, the integrity of the blockchain remains verifiable using the headers of the plurality of blocks in the blockchain, and deletion of transaction data in which the entity data of a smart contract not in use is stored is possible without being regarded as tampering.

Thus, data on the blockchain that has not been used for the predetermined period can be deleted, and blockchain enlargement can be minimized accordingly.

Furthermore, the control method according to the ninth aspect of the present disclosure is the control method according to the eighth aspect in which the deleting of the transaction data related to the first target includes: deleting, together with the first transaction data for deploying the first smart contract, second transaction data for calling up the first smart contract.

With this, the integrity of the blockchain remains verifiable using the headers of the plurality of blocks in the blockchain, and deletion of transaction data in which the entity data of a smart contract not in use is stored is possible without being regarded as tampering.

Thus, data on the blockchain that has not been used for the predetermined period can be deleted, and blockchain enlargement can be minimized accordingly.

Furthermore, the control method according to the tenth aspect of the present disclosure is the control method according to the eighth or ninth aspect in which a header of metadata and transaction data for a plurality of transactions are stored in each of a plurality of blocks included in the blockchain, the metadata including a hash value of an immediately preceding block and a transaction tree in which the transaction data for the plurality of transactions included in the block is summarized in a Merkle tree, the transaction data for the plurality of transactions being body data, an account list is further stored in the header, the account list describing information related to an account address created when the first smart contract is deployed, and the deleting of the transaction data related to the first target further includes: deleting information related to the account address from one or more account lists describing the account address among a plurality of account lists included in the plurality of blocks.

With this, because the integrity of the blockchain can remain verifiable using the headers of the plurality of blocks in the blockchain, deletion of transaction data of the smart contract that is the first target is possible without being regarded as tampering.

Furthermore, the control method according to the eleventh aspect of the present disclosure is the control method according to any one of the eighth to tenth aspect in which a world state indicating a state of an entire network of the blockchain is further stored in an in-memory database of each of the plurality of nodes, and the control method further includes: before the deleting of the transaction data related to the first target, deleting information of the first smart contract that is included in the world state.

With this, because the integrity of the blockchain can remain verifiable using the headers of the plurality of blocks in the blockchain, deletion of transaction data related to the smart contract that is the first target is possible without being regarded as tampering.

Furthermore, a server according to one aspect of the present disclosure includes a processor and memory. Using the memory, the processor performs the following: determining presence or absence of transaction data related to a first target that has not been used for a predetermined period among targets each being transaction data stored in a blockchain; and deleting the transaction data related to the first target from the blockchain based on a determination result indicating that the transaction data related to the first target is present.

Hereinafter, an exemplary embodiment will be described with reference to the drawings. Note that each exemplary embodiment described below shows one specific preferred example of the present disclosure. In other words, the numerical values, structural elements, the arrangement and connection of the structural elements, steps, the processing order of the steps etc., shown in the following exemplary embodiment are mere examples, and are not intended to limit the present disclosure. The present disclosure is defined based on the recitations of the Claims. Therefore, among the structural elements in the following exemplary embodiment, structural elements not recited in any one of the independent claims are not necessarily required to achieve the object of the present disclosure, but are described as structural elements of a more preferred exemplary embodiment.

### Exemplary Embodiment

Hereinafter, a control system according to an exemplary embodiment will be described with reference to the drawings.

### [Configuration of Control System]

The control system according to the present disclosure controls a blockchain that is managed by a plurality of nodes and in order to minimize blockchain enlargement, deletes unnecessary transaction data from a plurality of blocks included in the blockchain, in such a manner that the deletion is not regarded as tampering.

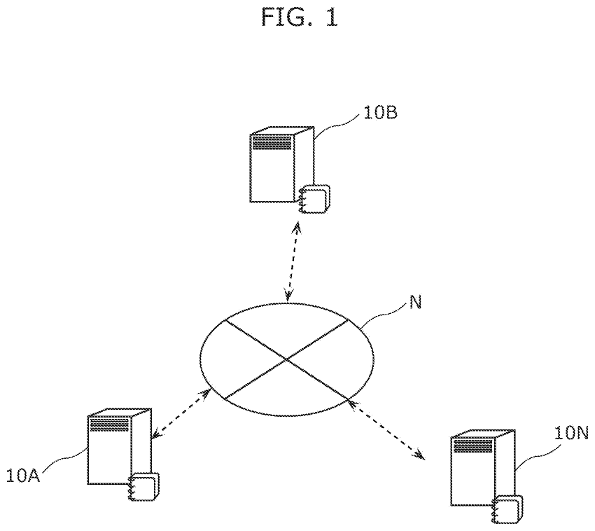

FIG. 1 is a schematic block diagram illustrating the configuration of the control system according to the present exemplary embodiment.

The control system according to the present exemplary embodiment includes BC node 10A, BC node 10B, and BC node 10N, as illustrated in FIG. 1. These are connected via network N so as to be able to communicate with each other. Examples of network N, which may be any communication line or any network, include the Internet and a cell-phone carrier network. BC node 10A, BC node 10B, or BC node 10N may be hereinafter referred to as “BC node 10”. Note that FIG. 1 illustrates an example in which the control system includes three BC nodes 10, but this is not limiting. Specifically, the control system may include four or more BC nodes 10.

### [Data Structure]

The data structure of blockchain 100 and the data structure of block n will be described.

### <Data Structure of Blockchain 100>

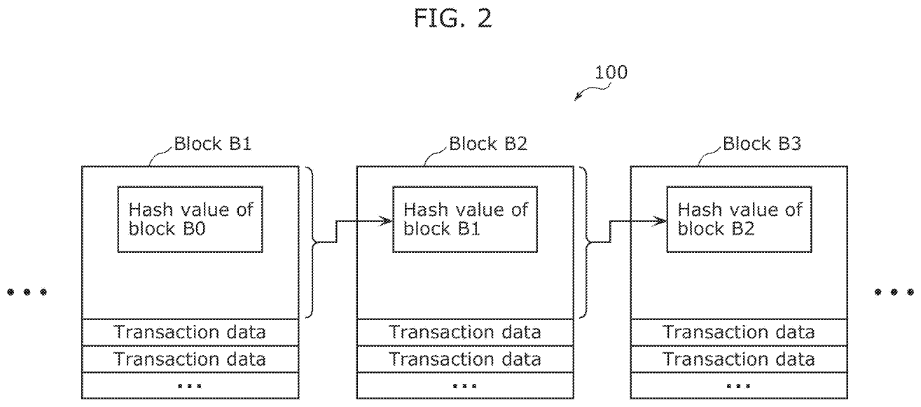

FIG. 2 is an explanatory diagram illustrating the data structure of blockchain 100 according to the exemplary embodiment.

A blockchain is made up of blocks, each of which is a recording unit of the blockchain, linked together in the form of a chain. Each of the blocks includes transaction data for a plurality of transactions and a hash value of an immediately preceding block. Specifically, block B2 includes the hash value of previous block B1. Furthermore, a hash value calculated using the hash value of block B1 and the transaction data for the plurality of transactions included in block B2 is included in block B3 as the hash value of block B2. In this manner, blocks are linked together in the form of a chain while including the content of previous blocks; thus, the recorded transaction data is effectively prevented from being tempered with.

If previous transaction data is changed, the hash value of the block becomes different from the original value, meaning that in order to make the block tampered with look correct, all the subsequent blocks need to be recreated, which is an extremely difficult task in practice. Using this feature, it is ensured that the blockchain is tamper-proof.

### <Data Structure of Block>

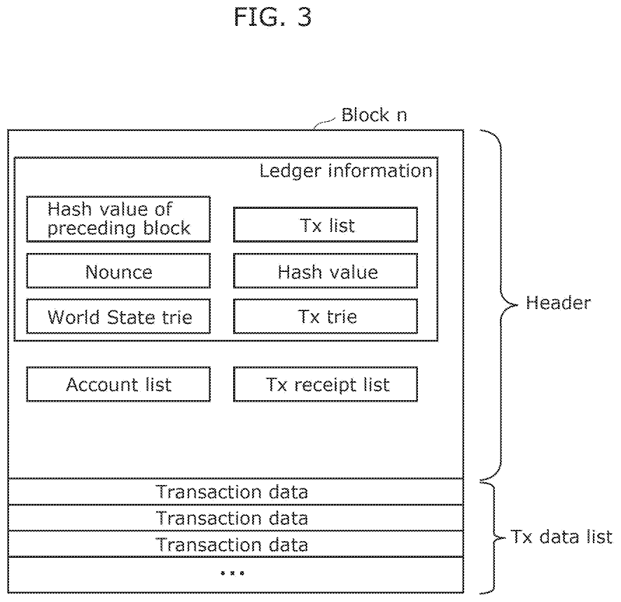

FIG. 3 is an explanatory diagram illustrating the data structure of block n in blockchain 100 according to the present exemplary embodiment. In FIG. 3, the data structure of block n which is one of the plurality of blocks included in blockchain 100 is schematically illustrated as a representative example.

In each of the plurality of blocks included in blockchain 100, stored is the header of metadata including, in addition to the hash value of the immediately preceding block, a transaction tree in which transaction data for a plurality of transactions included in said block is summarized in a Merkle tree, for example. Furthermore, in each of the plurality of blocks included in blockchain 100, the transaction data for the plurality of transactions that is body data is stored.

More specifically, block n according to the present exemplary embodiment includes a header and transaction data for a plurality of transactions, and the header includes ledger information, an account list, and a Tx receipt list, as illustrated in FIG. 3.

The ledger information includes the hash value of a preceding block, Nounce, a Tx list, a hash value, World state trie, and Tx trie, as information of block n.

In the hash value of the preceding block, the hash value of the header of the preceding block is stored. In the Nounce, a numerical value generated at random to be used only once is stored. In the hash value, a hash value indicating block n is stored. In the Tx list, the hash value of the transaction data for each of the plurality of transactions entered into block n is stored.

In the World state trie, stored is the hash value of the root of the Merkle tree summarizing all account states after execution of all the transaction data included in block n. The hash value of the root that is stored in the World state trie can be calculated using, as a data source, a world state indicating the state of the entire network of blockchain 100. Note that the world state to be used as the data source is stored in the in-memory database of each of the plurality of nodes that manage blockchain 100.

The Tx trie is a transaction tree in which the transaction data for the plurality of transactions included in said block is summarized in the Merkle tree. Specifically, the hash value of the root of the Merkle tree summarizing all the transaction data included in block n is stored in the Tx trie. The Merkle tree has a tree structure obtained by recursively hashing the hash value of one data set. The root hash at the root of the tree has a value of a fixed size including the hash values of all the leaves, and the leaves of the tree have hash values of respective data in the data set. This means that the root hash includes the hash properties of all the leaves. Therefore, even a slight modification to data in the leaves will result in the root hash having a completely different value and thus, the root hash can be used later to verify whether the data has not been tampered with.

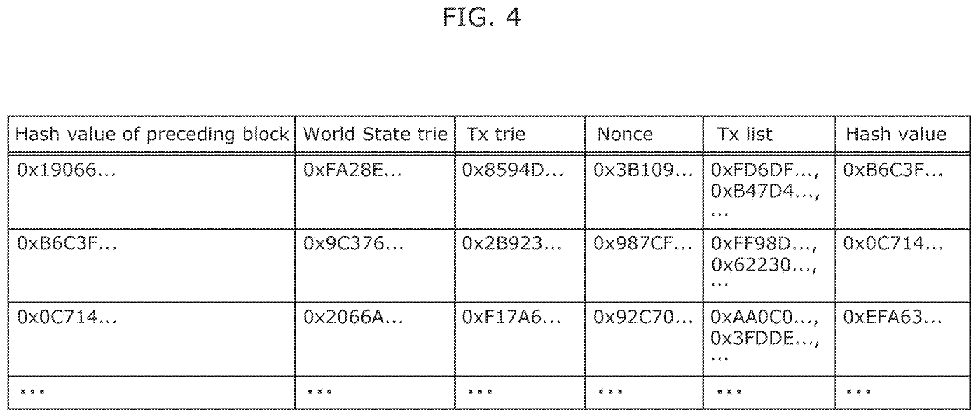

FIG. 4 is a diagram illustrating one example of the ledger information in the plurality of blocks included in blockchain 100 according to the present exemplary embodiment. In FIG. 4, an example of the ledger information in the plurality of blocks included in blockchain 100 is illustrated as a list. One row of the list illustrated in FIG. 4 corresponds to the ledger information of one block. The ledger information illustrated in FIG. 4 may also be referred to as a block list.

Referring back to FIG. 3, the description will be continued.

The Tx receipt list is information of the results of execution of the transaction data for the plurality of transactions included in block n that has been stored in a tree structure. More specifically, the hash value of the root of the Merkle tree summarizing the results of execution of all the transaction data included in block n is stored in the Tx receipt list.

The account list is account information stored in the header of block n. The account list describes monetary transaction information related to an account provided when a blockchain wallet is created. Furthermore, this account list may describe information related to an account address created when a smart contract is deployed.

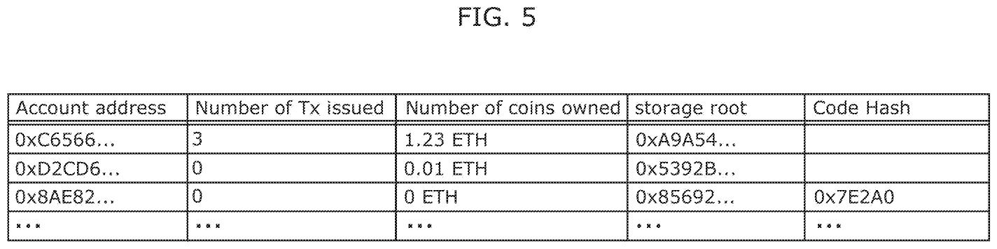

FIG. 5 is a diagram illustrating one example of the account list included in block n according to the present exemplary embodiment. In the present exemplary embodiment, when a blockchain wallet is created and when a smart contract is deployed, an account address is created as an account. In the example illustrated in FIG. 5, when an account address corresponds to a blockchain wallet, information regarding monetary transactions and information regarding the number of coins currently owned as a result of the monetary transactions are described in association with the account address. The number of Tx issued is information regarding monetary transactions. The number of coins owned is information regarding the number of coins currently owned; in FIG. 5, the number of coins owned is indicated in ETH which is a cryptocurrency in Ethereum. Note that the coins are one example of cryptocurrencies or cryptoassets that can be used in blockchain 100 and are not limited to cryptocurrencies or the like that can be used in Ethereum. When an account address corresponds to a smart contract, the hash value of the smart contract is described in Code Hash in association with the account address.

Referring back to FIG. 3, the description will be continued.

The transaction data for the plurality of transactions is stored in an area different from the header. The transaction data for the plurality of transactions is body data of a plurality of transaction information items described in the header, and transaction information or entity data is stored therein. In the present exemplary embodiment, each block manages the transaction data for the plurality of transactions in the Tx data list stored in the area different from the header.

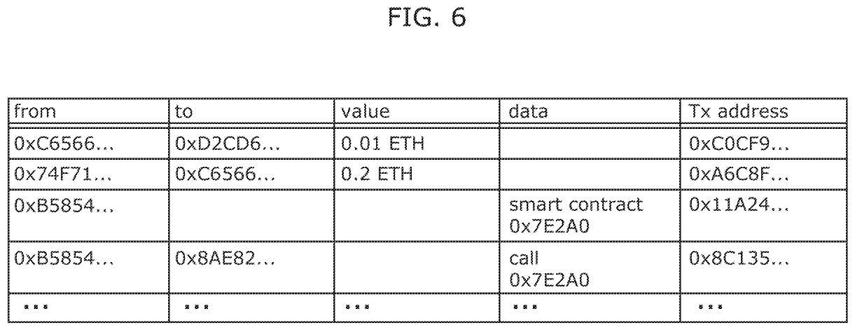

FIG. 6 is a diagram illustrating one example of the Tx data list included in block n according to the present exemplary embodiment. Block n according to the present exemplary embodiment identifies the transaction data for the plurality of transactions by Tx address and thus manages the transaction data for the plurality of transactions using the Tx data list.

There are four types of transaction data in Ethereum. Specifically, there are transaction data for making a monetary transaction, transaction data for deploying a smart contract, transaction data for calling up a smart contract, and other transaction data. The transaction data for making a monetary transaction is the transaction data related to the blockchain wallet and is used to send money from at least one wallet to at least one wallet. The transaction data for deploying a smart contract is used to register the program body of the smart contract into the blockchain. The transaction data for calling up a smart contract is used to call up the registered smart contract. Other transaction data is used to register data into the blockchain, for example.

In the present exemplary embodiment, the transaction data for the plurality of transactions is mainly used to transmit coins, deploy a smart contract, and call up a smart contract. Furthermore, specific transaction data to be used to register data into the blockchain (the specific transaction data) may be used. The transaction data to be used to transmit coins includes: the addresses of a transmission source and a transmission destination; and the number of coins to be transmitted. The transaction data to be used to deploy a smart contract includes: the hash value of the smart contract; and binary data (not illustrated in the drawings) of the program body of said smart contract. The transaction data to be used to call up a smart contract includes: the addresses of a transmission source and a transmission destination; and the hash value of the smart contract to be called up.

### [BC Node 10]

Each of the plurality of BC nodes 10 manages blockchain 100. BC nodes 10A, 10B, 10N illustrated in FIG. 1 are nodes that are connected via network N so as to be able to communicate with each other and each of which operates independently. BC nodes 10A, 10B, 10N have substantially the same configurations and therefore will be described below as BC node 10.

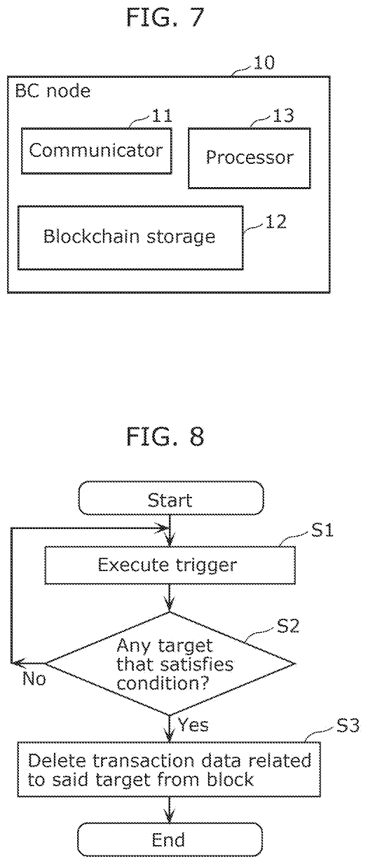

FIG. 7 is a schematic block diagram illustrating the configuration of BC node 10 according to the present exemplary embodiment.

BC node 10 is a server, for example, but may be a smartphone, a tablet, or a personal computer. In the present exemplary embodiment, BC node 10 includes communicator 11, blockchain storage 12, and processor 13, as illustrated in FIG. 7. These function parts included in BC node 10 may each be realized by a processor such as a central processing unit (CPU) executing a program using memory, for example.

### <Communicator 11>

Communicator 11 which is a wired or wireless communication interface communicates with another BC node 10 and communicates with a user terminal (not illustrated in the drawings) connected to network N, for example.

In the present exemplary embodiment, communicator 11 transmits and obtains transaction data. Furthermore, communicator 11 obtains information included in the header of a block in blockchain 100.

### <Blockchain Storage 12>

In blockchain storage 12, blockchain 100 having the same content as blockchain 100 in another BC node 10, etc., is stored. This means that blockchain storage 12 is a storage device in which blockchain 100 is stored. Blockchain storage 12 is provided as a hard disc drive (HDD), a solid state drive (SSD), or the like.

### <Processor 13>

Processor 13 may be realized by a processor such as a CPU executing a program using memory, for example. Upon execution of a trigger, processor 13 checks whether there is a first target that satisfies a predetermined condition among targets that are transaction data for making a monetary transaction, transaction data for deploying a smart contract, transaction data for calling up a smart contract, and other transaction data. When the first target that satisfies the predetermined condition is included, processor 13 deletes transaction data related to the first target from one or more blocks in blockchain 100.

The trigger may be executed regularly or every time a block is generated, in accordance with the specification of blockchain 100 or a rule recorded in a ledger, that is, a block, in blockchain 100, for example. In this case, the rule that a blockchain wallet or a smart contract that satisfies the predetermined condition is to be deleted may be set as the specification of the blockchain or may be recorded in the ledger in the blockchain. Furthermore, the trigger may be executed when delete request transaction data indicating that the first target is to be deleted is recorded into the blockchain.

The predetermined condition is a condition indicating whether the target is no longer needed; for example, the predetermined condition is that the target has not been used for a predetermined period. The predetermined period is set, as appropriate; for example, it is sufficient that the predetermined period be a long period such as one year. Note that the predetermined period may be set to be different for each first target, specifically, depending on whether the first target is a blockchain wallet, a smart contract, or specific transaction data, or may be set to be different for each blockchain wallet, for example, even among the same targets. Furthermore, when the target is a blockchain wallet, the predetermined condition may be that the remaining amount of coins has reached zero.

Furthermore, processor 13 can create a smart contract by user input or with control performed by a terminal operated by a user. Moreover, by user input or with control performed by a terminal operated by a user, processor 13 creates transaction data and executes a consensus algorithm for the transaction data with other BC nodes 10, for example. Processor 13 also performs the process of writing, into a block in blockchain 100, the transaction data for which the consensus algorithm has been executed. Furthermore, processor 13 also performs the process of executing a smart contract that has been written into a block in blockchain 100 and is operating in the in-memory database.

In the present exemplary embodiment, processor 13 deletes, from the plurality of blocks in blockchain 100, transaction data related to the first target that has not been used for the predetermined period among targets, each of which is a blockchain wallet, a smart contract, or specific transaction data. Note that when transaction data including an address indicating the first target has not been obtained or recorded into blockchain 100 for a predetermined period, processor 13 may determine that the first target has not been used for the predetermined period. When processor 13 deletes the transaction data related to the first target from the plurality of blocks in blockchain 100, processor 13 may create, as a certificate of deletion, transaction data indicating that said transaction data has been deleted, and record the transaction data into blockchain 100.

Furthermore, according to input, etc., from a user who created the first target, processor 13 may create delete request transaction data indicating that the first target is to be deleted. In this case, in order to delete the first target that has not been used for a predetermined period, the delete request transaction data is created according to the user who created the first target. When the delete request transaction data is recorded into blockchain 100, processor 13 deletes the transaction data related to the first target.

Note that when the account list is stored in a header in blockchain 100, processor 13 not only deletes the transaction data related to the first target from the block, but also deletes information related to the first target from the account list. Thus, the integrity of blockchain 100 can remain verifiable using the headers of the plurality of blocks in blockchain 100. Furthermore, when a world state indicating the state of the entire network of blockchain 100 is stored in the in-memory database of each of the plurality of BC nodes 10, processor 13 deletes information related to the first target included in the world state. This allows blockchain 100 to properly operate even if the value of the world state stored in the in-memory database is rewritten due to the transaction data related to the first target.

Now, assume, for example, that the first target is a first blockchain wallet. In this case, processor 13 deletes first transaction data including a deleted second blockchain wallet as a transmission source or a transmission destination among transaction data including the first blockchain wallet as a transmission source or a transmission destination. The second blockchain wallet is a blockchain wallet different from the first blockchain wallet. This allows transaction data that is the body data of transaction information of the first blockchain wallet that is the first target not in use to be deleted while the integrity of the blockchain remains verifiable using the headers of the plurality of blocks in blockchain 100.

Furthermore, assume that the header further holds an account list describing monetary transaction information related to an account provided when a blockchain wallet is created.

In this case, processor 13 deletes the information of the first blockchain wallet from one or more account lists that describe the information of the first blockchain wallet among the plurality of account lists included in the plurality of blocks. This allows the integrity of the blockchain to remain verifiable using the headers of the plurality of blocks in blockchain 100.

Furthermore, when the world state is stored in the in-memory database of each of the plurality of BC nodes 10, it is sufficient that before deleting the transaction data related to the first target, processor 13 delete the information of the first blockchain wallet included in the world state. The information of the first blockchain wallet that is included in the world state and is to be deleted is information of a sender and a recipient that used the first blockchain wallet, for example. Thus, it is possible to allow blockchain 100 to properly operate even if the value of the world state stored in the in-memory database is rewritten due to the transaction data related to the first blockchain wallet that is the first target.

Alternatively, assume, for example, that the first target is a first smart contract. In this case, processor 13 may delete first transaction data for deploying the first smart contract. Furthermore, processor 13 may delete not only the first transaction data for deploying the first smart contract, but also second transaction data for calling up the first smart contract. This allows transaction data that is the body data of transaction information of the first smart contract that is the first target not in use to be deleted while the integrity of the blockchain remains verifiable using the headers of the plurality of blocks in blockchain 100.

Furthermore, assume that the header further holds an account list describing information related to an account address created when the first smart contract is deployed.

In this case, processor 13 deletes the information related to said account address from one or more account lists that describe the account address created when the first smart contract is deployed, among the plurality of account lists included in the plurality of blocks. This allows the integrity of the blockchain to remain verifiable using the headers of the plurality of blocks in blockchain 100.

Furthermore, when the world state is stored in the in-memory database of each of the plurality of BC nodes 10, it is sufficient that before deleting the transaction data related to the first target, processor 13 delete the information of the first smart contract included in the world state. This allows blockchain 100 to properly operate even if the value of the world state stored in the in-memory database is rewritten due to the transaction data related to the first smart contract that is the first target.

### [Operation]

The following will describe the broad outline of processing in which BC node 10 configured as described above deletes entity data from blockchain 100.

### [Broad Outline of Processing]

FIG. 8 is a flowchart illustrating the broad outline of processing according to the present exemplary embodiment in which BC node 10 deletes entity data from blockchain 100. As described above, each of the plurality of blocks included in blockchain 100 holds a header of metadata including, in addition to the hash value of the immediately preceding block, a transaction tree in which transaction data for a plurality of transactions included in said block is summarized in a Merkle tree. Furthermore, in each of the plurality of blocks included in blockchain 100, the transaction data for the plurality of transactions that is body data is stored at a position different from the position of the header.

In BC node 10, a trigger is executed regularly or every time a block is generated, in accordance with the specification of blockchain 100 or a rule recorded in a ledger, that is, a block, in the blockchain, for example (S1).

Next, BC node 10 checks whether targets, each of which is a blockchain wallet, a smart contract, or specific transaction data, include a target that satisfies a predetermined condition (S2).

When there is no target that satisfies the predetermined condition in Step S2 (No in Step 2), the processing returns to Step S1.

On the other hand, when there is a target that satisfies the predetermined condition (Yes in S2), BC node 10 deletes the transaction data related to said target from the block in blockchain 100 (S3). For example, BC node 10 deletes, from the plurality of blocks included in blockchain 100, the transaction data related to the first target that has not been used for the predetermined period among the targets, each of which is a blockchain wallet, a smart contract, or specific transaction data.

### Example Processing for Blockchain Wallet

The following will describe example processing to be performed when the target, the body data of which is to be deleted, is a blockchain wallet. The present example processing will be described assuming that an account list such as that illustrated in FIG. 5, for example, describing monetary transaction information related to an account provided when a blockchain wallet is created is further stored in the headers of the plurality of blocks included in blockchain 100. Furthermore, assume that transaction data for a plurality of transactions included in a deletion target block in the following description is managed as a result of a Tx data list such as that illustrated in FIG. 6, for example, being stored into said block.

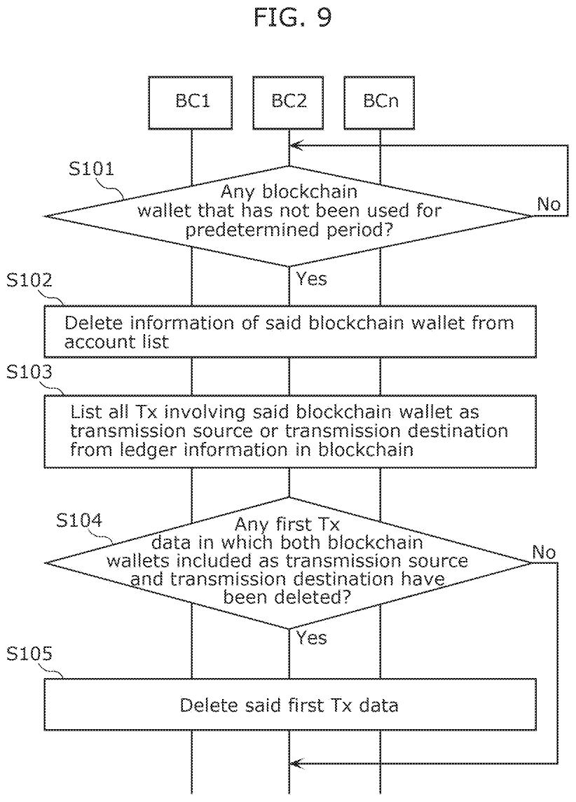

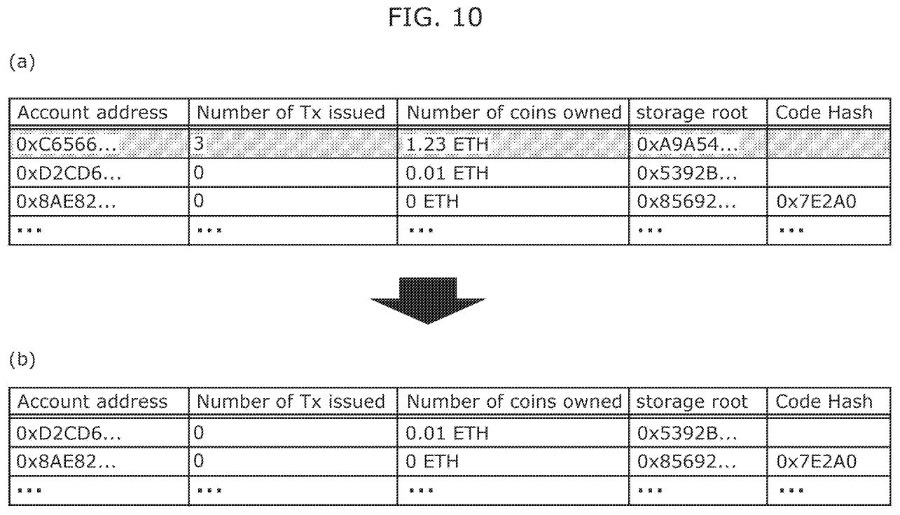

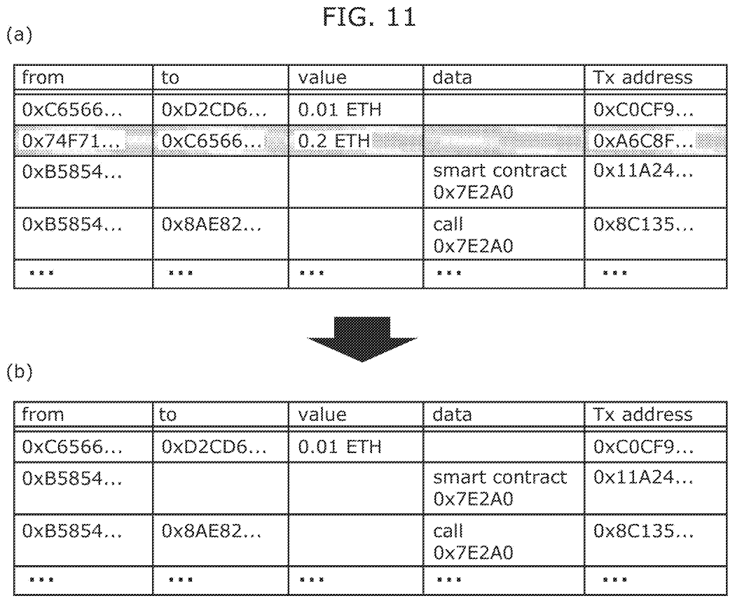

FIG. 9 is a flowchart illustrating example processing for a blockchain wallet according to the present exemplary embodiment. FIG. 9 illustrates BC1, BC2, and BCn as an example of the plurality of BC nodes 10 and shows example processing in which BC node 10 deletes the entity data of a blockchain wallet from blockchain 100. FIG. 10 is a diagram illustrating an example in which an account list is deleted in example processing for a blockchain wallet according to the present exemplary embodiment. FIG. 11 is a diagram illustrating an example in which a Tx data list is deleted in example processing for a blockchain wallet according to the present exemplary embodiment.

First, BC1, BC2, or BCn, that is, BC node 10, checks whether there is any blockchain wallet that has not been used for a predetermined period (S101). BC node 10 performs the process in Step S101 regularly or every time a block is generated, in accordance with the specification of blockchain 100 or a rule recorded in a ledger, that is, a block, in the blockchain, for example. Furthermore, BC node 10 may check whether transaction data including an address indicating a target has not been obtained (or referred to) for the predetermined period to check whether there is any blockchain wallet as a target that has not been used for the predetermined period.

When there is no blockchain wallet that has not been used for the predetermined period in Step S101 (No in S101), the processing returns to Step S101.

On the other hand, when there is a blockchain wallet that has not been used for the predetermined period in Step S101 (Yes in S101), BC node 10 deletes the information of said blockchain wallet from the account list (S102).

A description will now be given using the example illustrated in FIG. 10. The account list illustrated in (a) in FIG. 10 is the account list illustrated in FIG. 5. In this case, BC node 10 deletes, as the information of the blockchain wallet not in use, the row including the account address “0xC6566 . . . ” from the account list illustrated in (a) in FIG. 10. FIG. 10 illustrates, in (b), the account list from which the information of the blockchain wallet not in use has been deleted. In this manner, BC node 10 deletes the information of the blockchain wallet not in use from the account list.

Next, BC node 10 lists all Tx involving said blockchain wallet as a transmission source or a transmission destination from the ledger information in blockchain 100 (S103).

Next, BC node 10 checks whether the listed Tx include Tx data in which the blockchain wallets included as a transmission source and a transmission destination have been deleted from the account list, namely, first transaction data (referred to as first Tx data) (S104).

When the first Tx data is not found in Step S104 (No in S104), BC node 10 ends the processing.

On the other hand, when the first Tx data is found in Step S104 (Yes in S104), BC node 10 deletes the first Tx data from the block in blockchain 100 as the transaction data related to said target (S105).

A description will now be given using the example illustrated in FIG. 11. The Tx data list illustrated in (a) in FIG. 11 is the Tx data list illustrated in FIG. 6. Assume that the account address indicating the blockchain wallet not in use is “0xC6566 . . . ” and the information of the blockchain wallet having the account address “0x74F71 . . . ” has already been deleted from the account list. Furthermore, in BC node 10, the information of the blockchain wallet having the account address “0xC6566 . . . ” has been deleted from the account list, as illustrated in (b) in FIG. 10. Therefore, in BC node 10, as the transaction data related to the blockchain wallet not in use, transaction data in a row in which the account address “0xC6566 . . . ” is included as a transmission destination is deleted from the Tx data list illustrated in (a) in FIG. 11. FIG. 11 illustrates, in (b), the Tx data list from which the transaction data related to the blockchain wallet not in use has been deleted. Note that since the blockchain wallet having the account address “0x74F71 . . . ” has already been deleted, BC node 10 can delete the transaction data in this row in which the account address “0x74F71 . . . ” is included as a transmission source. In other words, BC node 10 deletes transaction data in which another deleted blockchain wallet is included as a transmission source or a transmission destination among transaction data in which a blockchain wallet not in use is included as a transmission source or a transmission destination.

In this manner, the transaction data related to the blockchain wallet not in use can be deleted while the integrity of blockchain 100 remains verifiable using the headers of the plurality of blocks in blockchain 100.

### Example Processing 1 for Smart Contract

The following will describe example processing to be performed when the target, the body data of which is to be deleted, is a smart contract. The present example processing will be described assuming that an account list such as that illustrated in FIG. 5, for example, describing information related to an account address created when the first smart contract is deployed is further stored in the headers of the plurality of blocks included in blockchain 100. Furthermore, assume that transaction data for a plurality of transactions included in a deletion target block in the following description is managed as a result of a Tx data list such as that illustrated in FIG. 6, for example, being stored into said block.

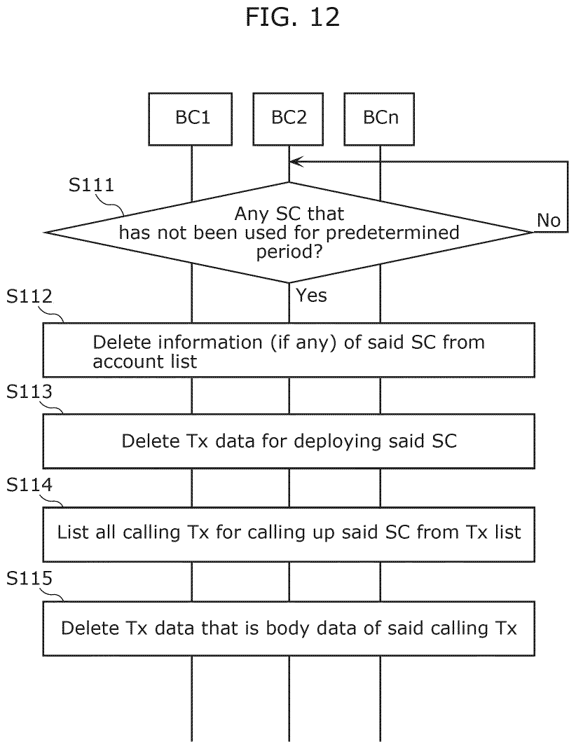

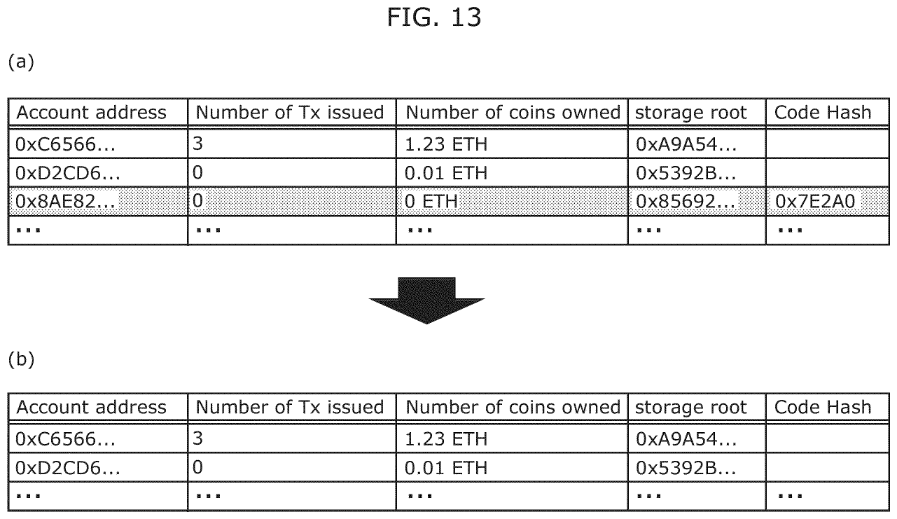

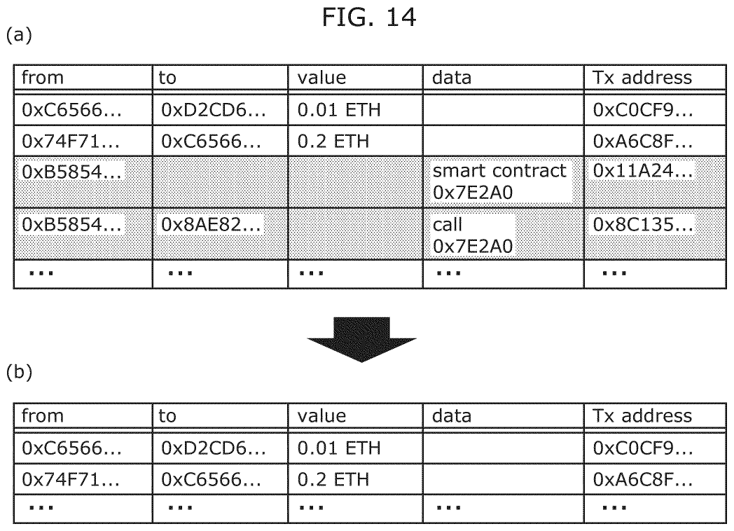

FIG. 12 is a flowchart illustrating example processing 1 for a smart contract according to the present exemplary embodiment. FIG. 12 illustrates BC1, BC2, and BCn as an example of the plurality of BC nodes 10 and shows example processing in which BC node 10 deletes the entity data of the smart contract from blockchain 100. FIG. 13 is a diagram illustrating an example in which an account list is deleted in example processing 1 for a smart contract according to the present exemplary embodiment. FIG. 14 is a diagram illustrating an example in which a Tx data list is deleted in example processing 1 for a smart contract according to the present exemplary embodiment.

First, BC1, BC2, or BCn, that is, BC node 10, checks whether there is any smart contract (indicated as SC in the drawings) that has not been used for a predetermined period (S111). BC node 10 performs the process in Step S111 regularly or every time a block is generated, in accordance with the specification of blockchain 100 or a rule recorded in a ledger, that is, a block, in the blockchain, for example. Furthermore, BC node 10 may check whether transaction data including an address indicating a target has not been obtained (or referred to) for the predetermined period to check whether there is any smart contract as a target that has not been used for the predetermined period.

When there is no smart contract that has not been used for the predetermined period in Step S111 (No in S111), the processing returns to Step S111.

On the other hand, when there is a smart contract that has not been used for the predetermined period in Step S111 (Yes in S111), BC node 10 deletes the information of said smart contract from the account list (S112).

A description will now be given using the example illustrated in FIG. 13. The account list illustrated in (a) in FIG. 13 is the account list illustrated in FIG. 5. In this case, BC node 10 deletes, as the information of the smart contract not in use, the row including the account address “0x8AE82 . . . ” from the account list illustrated in (a) in FIG. 13. FIG. 13 illustrates, in (b), the account list from which the information of the smart contract not in use, that is, the information related to the account address of the smart contract not in use, has been deleted. In this manner, BC node 10 deletes the information of the smart contract not in use from the account list.

Next, BC node 10 deletes the Tx data for deploying the smart contract not in use from the block, that is, the Tx data list, in blockchain 100 as the transaction data related to said target (S113).

A description will now be given using the example illustrated in FIG. 14. The Tx data list illustrated in (a) in FIG. 14 is the Tx data list illustrated in FIG. 6. BC node 10 deletes the transaction data for deploying the smart contract having the code hash value “0x7E2A0 . . . ” from the Tx data list illustrated in (a) in FIG. 14 as the transaction data related to the smart contract not in use. FIG. 14 illustrates, in (b), the Tx data list from which the transaction data for deploying the smart contract having the code hash value “0x7E2A0 . . . ” has been deleted as the transaction data related to the smart contract not in use.

Next, BC node 10 lists all calling Tx which is transaction information for calling up said smart contract from the ledger information, that is, the Tx list, in blockchain 100 (S114).

Next, BC node 10 deletes, from the block in blockchain 100, transaction data (Tx data in the drawings) that is the body data of all the listed calling Tx (S115).

A description will now be given using the example illustrated in FIG. 14. BC node 10 deletes the transaction data that is the Tx data for calling up the smart contract having the code hash value “0x7E2A0 . . . ” from the Tx data list illustrated in (a) in FIG. 14 as the transaction data related to the smart contract not in use. FIG. 14 illustrates, in (b), the Tx data list from which the transaction data for calling up the smart contract having the code hash value “0x7E2A0 . . . ” has been deleted as the transaction data related to the smart contract not in use. This means that BC node 10 deletes the Tx data for calling up the smart contract not in use from the Tx data list.

Thus, the transaction data in which the entity data, i.e., the program body, of the smart contract not in use is stored can be deleted while the integrity of blockchain 100 remains verifiable using the headers of the plurality of blocks in blockchain 100.

### Example Processing 2 for Smart Contract

The following will describe other example processing to be performed when the target, the body data of which is to be deleted, is a smart contract. In the present example processing described below, the entity data of a smart contract is deleted as triggered by storing of delete request transaction data for requesting deletion of the entity data of the smart contract into blockchain 100. Note that detailed description of processing that is substantially the same as the processing described with reference to FIG. 12 will be omitted. Note that as in the above example processing, it is assumed that an account list such as that illustrated in FIG. 5, for example, describing information related to an account address created when the first smart contract is deployed is further stored in the headers of the plurality of blocks included in blockchain 100. Furthermore, assume that transaction data for a plurality of transactions included in a deletion target block in the following description is managed as a result of a Tx data list such as that illustrated in FIG. 6, for example, being stored into said block.

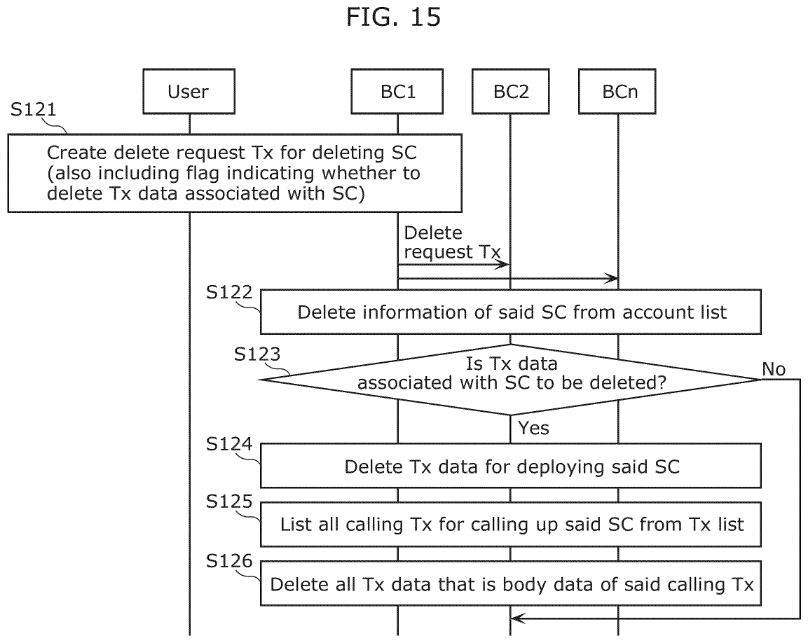

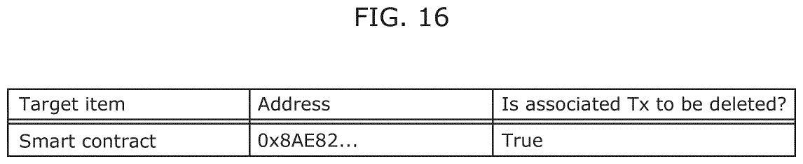

FIG. 15 is a flowchart illustrating example processing 2 for a smart contract according to the present exemplary embodiment. FIG. 15 illustrates BC1, BC2, and BCn as an example of the plurality of BC nodes 10 and shows example processing 2 in which BC node 10 deletes the entity data of a smart contract from blockchain 100. FIG. 16 is a diagram illustrating one example of information included in delete request transaction data according to example processing 2 for a smart contract according to the present exemplary embodiment.

First, a user operates BC1, which is one of BC nodes 10, to cause BC1 to create delete request transaction data indicating that the smart contract created by the user is to be deleted (S121). In Step S121, for example, when said smart contract is no longer needed, such as when said smart contract has not been used for one year, it is sufficient that a user cause BC1 to create delete request transaction data. The user can decide whether to delete the transaction data for calling up said smart contract in addition to the transaction data for deploying said smart contract as deletion of the entity data of said smart contract. In deleting the transaction data for calling up said smart contract, it is sufficient that the user additionally provide, for example, information such as a flag that specifies whether to delete transaction data associated with said smart contract. To describe using the example illustrated in FIG. 16, it is sufficient that delete request transaction data be created which includes: said smart contract and the address thereof “0x8AE82 . . . ” as a deletion target indicated in the target item and the address thereof; and True as a flag indicating whether to delete associated Tx.

Next, when the delete request transaction data is recorded into blockchain 100, BC1, BC2, or BCn, that is, BC node 10, deletes the information of said smart contract from the account list (S122). Details thereof are as described above with reference to FIG. 13 and thus, description thereof will be omitted.

Next, by checking the flag included in the delete request transaction data recorded into blockchain 100, BC node 10 checks whether to delete the transaction data (Tx data in the drawings) associated with said smart contract (S123).

When it is determined in Step S123 that the transaction data associated with said smart contract is not to be deleted (No in S123), BC node 10 ends the processing.

On the other hand, when it is determined in Step S123 that the transaction data associated with said smart contract is to be deleted (Yes in S123), BC node 10 deletes, from blockchain 100, the Tx data for deploying the smart contract not in use (S124). The Tx data for deploying the smart contract not in use corresponds to the transaction data related to said target. BC node 10 deletes the Tx data for deploying the smart contract not in use from the block in blockchain 100 by deleting said Tx data from the Tx data list included in the block.

Subsequent Steps S125 and S126 are processes that are substantially the same as Steps S114 and S115 described above, and thus description thereof will be omitted.

### [Advantageous Effects, Etc.]

As described above, in the control method, etc., according to the present disclosure, transaction data related to a blockchain wallet that is the first target that has not been used for a predetermined period, transaction data related to a smart contract that is the first target that has not been used for a predetermined period, or specific transaction data that is the first target that has not been used for a predetermined period is deleted from blockchain 100. Thus, it is possible to provide a control method in which blockchain enlargement can be minimized.

The blockchain is verified using the headers of the plurality of blocks in the blockchain. More specifically, the blockchain is verified using the transaction tree included in the header of each of the plurality of blocks in the blockchain. In the transaction tree, stored are the hash values of the transaction data for the plurality of transactions included in the block that is summarized in the Merkle tree. This means that the verification of the blockchain does not require the transaction data for the plurality of transactions which is the body data (in other words, the entity data) of the plurality of transaction information items included in the block. Therefore, as long as there is a match in the information included in the headers of the plurality of blocks, deletion of the body data of the transaction information of the first target causes no problems.

Thus, because the integrity of the blockchain remains verifiable using the headers of the plurality of blocks in the blockchain, deletion of transaction data that is the body data of transaction information of the first target not in use is possible without being regarded as tampering.

Note that deletion of transaction data that is the body data of transaction information of the first target that has not been used for a predetermined period from a block may seem to constitute tampering with the block. However, the transaction tree or the like included in the block has not been changed and there is a match in the information included in the headers of the plurality of blocks; therefore, the deletion does not constitute tampering with the block. Furthermore, tampering with a block requires simultaneous operation of at least 50% of the plurality of nodes that manage the blockchain. Therefore, even deletion of transaction data that is the body data of the transaction information of the first target not in use does not degrade the safety of the blockchain.

When the delete request transaction data created by a user who created the first target and indicating that the first target is to be deleted is obtained and recorded into the blockchain, the transaction data related to the first target may be deleted. Thus, obtainment of the delete request transaction data created by a user who created the first target that has not been used for a predetermined period can be a trigger to delete the transaction data related to the first target from the plurality of blocks in the blockchain.

Furthermore, in the control method, etc., according to the present disclosure, when transaction data including an address indicating the first target has not been referred to for a predetermined period, the transaction data related to the first target may be deleted. Thus, the fact that the transaction data including the address indicating the first target has not been referred for the predetermined period can be a trigger to delete the transaction data related to the first target from the plurality of blocks in the blockchain.

Furthermore, in the control method, etc., according to the present disclosure, when there is a blockchain wallet in which the remaining amount of coins has reached zero, the transaction data related to the blockchain wallet may be deleted. Specifically, regarding a blockchain wallet, when the amount of coins that are a cryptocurrency or the like to be exchanged in the blockchain wallet reaches zero, the transaction data related to the blockchain wallet may be deleted from the plurality of blocks in the blockchain.

Thus, when the blockchain wallet is of the disposable type, the blockchain wallet will not be used after the remaining amount of coins therein reaches zero and therefore, data in the blockchain that has not been used for a predetermined period can be deleted. Accordingly, blockchain enlargement can be minimized.

Assume now that the first target that has not been used for the predetermined period is the first blockchain wallet and the second blockchain wallet has been deleted from the account list. In this case, it is sufficient that the first transaction data including the first blockchain wallet and the second blockchain wallet as a transmission source or a transmission destination be deleted as the transaction data related to the blockchain wallet. Furthermore, it is sufficient that the information of the first blockchain wallet be deleted from the account list.

The transaction data related to the first blockchain wallet is transaction data related to a monetary transaction. If all the transaction data including the first blockchain wallet as a transmission source or a transmission destination, there is a possibility that the balances of other blockchain wallets can no longer be correctly calculated. However, when the blockchain wallets of both a coin sender and a coin recipient have been deleted, the balances will not be calculated, meaning that there are no problems. Therefore, when the blockchain wallets included in both a transmission source and a transmission destination have been deleted from the account data, the transaction data thereof can be deleted.

Thus, in the control method, etc., according to the present disclosure, the first blockchain wallet which is the first target is deleted from the account list, and transaction data including the blockchain wallet of a transmission source or a transmission destination that has been deleted from the account list is deleted.

With this, because the integrity of the blockchain can remain verifiable using the headers of the plurality of blocks in the blockchain, deletion of transaction data of the first blockchain wallet that is the first target is possible without being regarded as tampering.

Furthermore, there are cases where the world state is stored in the in-memory database of each of the plurality of nodes that manage the blockchain. In such a case, in the control method according to the present disclosure, it is sufficient that the information of the first blockchain wallet that is the first target be deleted from the world state before the transaction data related to the first target is deleted.

With this, because the integrity of the blockchain can remain verifiable using the headers of the plurality of blocks in the blockchain, deletion of transaction data of the first blockchain wallet that is the first target is possible without being regarded as tampering.

Furthermore, in the control method, etc., according to the present disclosure, transaction data for deploying a smart contract may be deleted from the plurality of blocks in the blockchain as the transaction data related to the first target that is a smart contract that has not been used for a predetermined period.

Furthermore, in the control method, etc., according to the present disclosure, together with transaction data for deploying a smart contract, transaction data for calling up the smart contract may be deleted from the plurality of blocks in the blockchain as the transaction data related to the first target that is a smart contract that has not been used for a predetermined period.

With this, the integrity of the blockchain remains verifiable using the headers of the plurality of blocks in the blockchain, and deletion of transaction data in which the entity data of a smart contract not in use is stored is possible without being regarded as tampering.

Thus, data on the blockchain that has not been used for the predetermined period can be deleted, and blockchain enlargement can be minimized accordingly.

Furthermore, there are case where an account list describing information related to an account address created when a smart contract is deployed is stored in the headers of the plurality of blocks in the blockchain. In such a case, the control method, etc., according to the present disclosure may further include: deleting the information related to the account address from the account list when deleting the transaction data related to the first target.

With this, because the integrity of the blockchain can remain verifiable using the headers of the plurality of blocks in the blockchain, deletion of transaction data of the smart contract that is the first target is possible without being regarded as tampering.

Furthermore, there are cases where the world state is stored in the in-memory database of each of the plurality of nodes that manage the blockchain. In such a case, in the control method according to the present disclosure, it is sufficient that the information of the smart contract that is the first target be deleted from the world state before the transaction data related to the first target is deleted.

With this, because the integrity of the blockchain can remain verifiable using the headers of the plurality of blocks in the blockchain, deletion of transaction data related to the smart contract that is the first target is possible without being regarded as tampering.

### Other Exemplary Embodiments, Etc.

The present disclosure has been described thus far based on the above exemplary embodiment, but it goes without saying that the present disclosure is not limited to the above exemplary embodiment. The following examples are also intended to be included within the scope of the present disclosure.

(1) With reference to FIG. 15 and FIG. 16, for example, the above exemplary embodiment describes the case where the entity data of a smart contract is deleted as triggered by storing of the delete request transaction data into blockchain 100, but this is not limiting. The same can apply to the case where transaction data related to a blockchain wallet is deleted and the case where specific transaction data is deleted, as described above. In this case, information included in the delete request transaction data is changed as appropriate.

For example, the target item included in the delete request transaction data may include a blockchain wallet, a smart contract, and specific transaction data. When the target item is a blockchain wallet, the associated Tx is transaction data for making a monetary transaction involving said blockchain wallet as a transmission source or a transmission destination. When the target item is a smart contract, the associated Tx is transaction data for deploying said smart contract and transaction data for calling up said smart contract.

(2) The above exemplary embodiment describes deleting transaction data that is the body data of the transaction information of the first target that satisfies a predetermined condition, in accordance with a rule recorded in a ledger, that is, a block, in blockchain 100, in the case of deletion from one or more blocks in blockchain 100. Furthermore, the above exemplary embodiment indicates that as the predetermined condition, a rule that the transaction data of the first target that satisfies the condition that the first target has not been used for a predetermined period is recorded in the ledger in blockchain 100, but this is not limiting.

A predetermined user or a service provider that provides blockchain 100 may, for example, operate BC node 10 to issue transaction data describing a condition indicating whether the target is no longer needed, that is, the content of a deletion rule. In this case, deletion rule setting transaction data describing the content of the deletion rule is written into blockchain 100 when agreed on by the majority of the plurality of BC nodes; in this manner, the deletion rule is set.

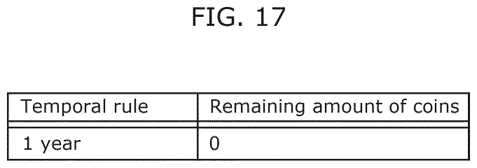

FIG. 17 is a diagram illustrating one example of information included in the deletion rule setting transaction data. FIG. 17 indicates that the temporal rule is one year and that the remaining amount of coins has reached zero. Specifically, FIG. 17 indicates that when the target has not been used for a predetermined period that is one year or when the remaining amount of coins reaches zero, the condition indicating whether the target is no longer need is satisfied. Note that one or both of the condition that the temporal rule is one year and the condition that the remaining amount of coins has reached zero may be specified.

(3) Blockchain 100 according to the present disclosure is not limited to an Ethereum-based blockchain when the integrity thereof is verifiable using the header of a block including no body data such as an Ethereum light node, for example. In other words, in the case where the integrity of the blockchain is verifiable using the headers of the plurality of blocks of the blockchain, the blockchain may be a new blockchain that is not based on Ethereum, and some node may manage a blockchain made up of blocks including no body data.

The following will describe: the data structure of a blockchain made up of blocks that do not include transaction data that is body data; and the data structure of block n (n is a natural number) that does not include transaction data that is body data.

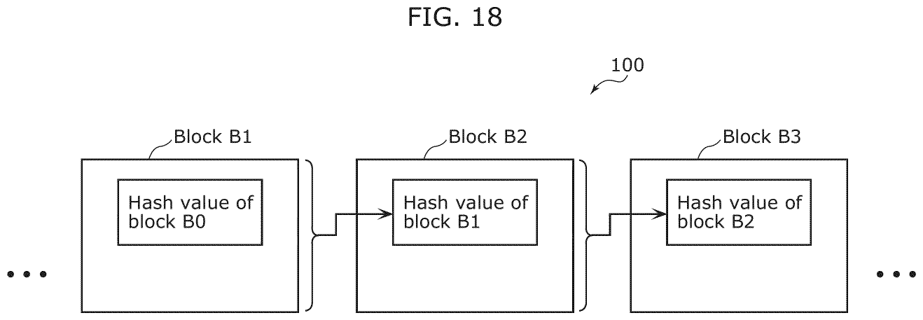

FIG. 18 is an explanatory diagram illustrating the data structure of blockchain 100 according to another exemplary embodiment. Description that is substantially the same as the description of FIG. 2 will be omitted.

Blockchain 100 illustrated in FIG. 18 is made up of blocks, each of which is a recording unit of the blockchain, linked together in the form of a chain, and does not include transaction data for a plurality of transactions as compared to blockchain 100 illustrated in FIG. 2. This means that one BC node 10 may manage, instead of blockchain 100 illustrated in FIG. 2, blockchain 100 such as that illustrated in FIG. 18 in which blocks each including a hash value of an immediately preceding block, but not including transaction data are connected. Specifically, in blockchain 100 illustrated in FIG. 18, block B2 includes the hash value of previous block B1. Furthermore, a hash value calculated using the hash value of block B1 and information included in the header of block B2 is included in block B3 as the hash value of block B2. Therefore, even blockchain 100 in which blocks each including no body data are connected in the form of a chain functions to effectively prevent tampering of the recorded transaction data, similar to blockchain 100 according to the above exemplary embodiment.

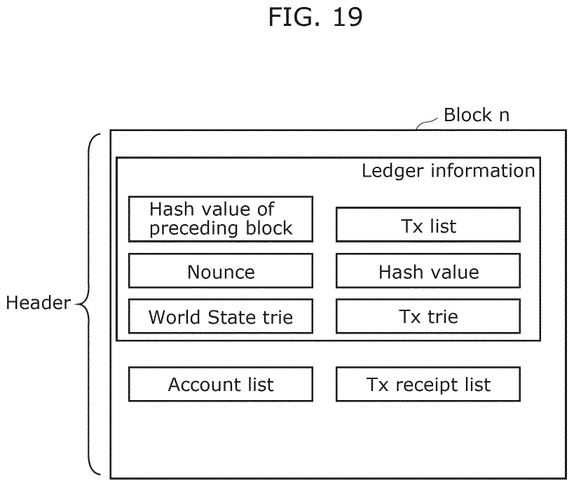

FIG. 19 is an explanatory diagram illustrating the data structure of block n in blockchain 100 according to another exemplary embodiment. In FIG. 19, the data structure of block n which is one of the plurality of blocks included in blockchain 100 is schematically illustrated as a representative example.

Block n illustrated in FIG. 19 is different from block n illustrated in FIG. 3 in that transaction data that is body data is not included.

Furthermore, the content of the Tx list included in the header of block n illustrated in FIG. 19 is different from the content of the Tx list included in the header of block n illustrated in FIG. 3. Specifically, the addresses of the transaction data for the plurality of transactions that is not included in block n illustrated in FIG. 19, but is included in block n illustrated in FIG. 3 are stored in the Tx list illustrated in FIG. 19. For example, the addresses of the transaction data for the plurality of transactions included in block n illustrated in FIG. 3 that are indicated in the far right column in FIG. 6 are stored in the Tx list illustrated in FIG. 19.

(4) Each of the devices according to the above exemplary embodiment is specifically a computer system configured from a microprocessor, a read-only memory (ROM), a random-access memory (RAM), a hard disk unit, a display unit, a keyboard, and a mouse, for example. A computer program is recorded in the RAM or the hard disk unit. Each of the devices achieves its function as a result of the microprocessor operating according to the computer program. Here, the computer program is configured of a combination of command codes indicating instructions to the computer in order to achieve a predetermined function.

(5) Some or all of the structural elements included in each of the devices according to the above exemplary embodiment device may be configured from a single system Large Scale Integration (LSI). A system LSI is a super-multifunction LSI manufactured with a plurality of components integrated on a single chip, and is specifically a computer system configured of a microprocessor, ROM, and RAM, for example. A computer program is recorded on the RAM. The system LSI achieves its function as a result of the microprocessor operating according to the computer program.

Furthermore, each unit of the structural elements included in each of the devices described above may be individually configured into a single chip, or some or all of the units may be configured into a single chip.

Moreover, although a system LSI is mentioned here, the integrated circuit can also be called an IC, a LSI, a super LSI, and an ultra LSI, depending on the level of integration. Furthermore, the method of circuit integration is not limited to LSIs, and implementation through a dedicated circuit or a general-purpose processor is also possible. A field programmable gate array (FPGA) which allows programming after LSI manufacturing or a reconfigurable processor which allows reconfiguration of the connections and settings of the circuit cells inside the LSI may also be used.

In addition, depending on the emergence of circuit integration technology that replaces LSI due to progress in semiconductor technology or other derivative technology, it is obvious that such technology may be used to integrate the function blocks. Possibilities in this regard include the application of biotechnology and the like.

(6) Some or all of the structural elements included in each of the devices described above may be implemented as a standalone module or an IC card that can be inserted into and removed from the device. The IC card or the module is a computer system made up of a microprocessor, ROM, RAM, and so on. The IC card or the module may include the aforementioned super multifunctional LSI. The IC card or the module achieves its functions as a result of the microprocessor operating according to the computer program. The IC card and the module may be tamper-proof.

(7) The present disclosure may be the above-described methods. Furthermore, the present disclosure may be a computer program for implementing these methods using a computer or may be a digital signal of the computer program.

Furthermore, the present disclosure may be the computer program or digital signal recorded on recording media readable by a computer, such as a flexible disk, a hard disk, a compact disc read-only memory (CD-ROM), a magneto-optical disc (MO), a digital versatile disc (DVD), a DVD-ROM, a DVD-RAM, a Blu-ray (registered trademark) disc (BD), or a semiconductor memory, for example. The present disclosure may also be the digital signal recorded on these recoding media.

Furthermore, in the present disclosure, the computer program or the digital signal may be transmitted via an electrical communication line, a wireless or wired communication line, a network represented by the Internet, data broadcasting, or the like.

Furthermore, the present disclosure may be a computer system including a microprocessor and memory. The memory may have the computer program recorded thereon, and the microprocessor may operate according to the computer program.

Moreover, by transferring the recording medium having the program or the digital signal recorded thereon or by transferring the program or the digital signal via the network or the like, the present disclosure may be implemented by a different independent computer system.

(8) The above exemplary embodiment and the above variations may be combined with each other.

### INDUSTRIAL APPLICABILITY

The present disclosure can be used for control methods, servers, and programs; for example, the present disclosure is applicable to a control method, a server, a program, etc., in which transaction data including unnecessary entity data is deleted to minimize blockchain enlargement.

1. A control method comprising:
determining presence or absence of transaction data related to a first target that has not been used for a predetermined period among targets each being transaction data stored in a blockchain; and
deleting the transaction data related to the first target from the blockchain based on a determination result indicating that the transaction data related to the first target is present.

2. The control method according to claim 1, further comprising:
obtaining delete request transaction data that is transaction data created by a user who has created the first target and indicates that the first target is to be deleted, wherein
when the delete request transaction data is recorded into the blockchain, the transaction data related to the first target is deleted.

3. The control method according to claim 1, wherein
when transaction data including an address indicating a target that is at least one of transaction data for making a monetary transaction, transaction data for deploying a smart contract, transaction data for calling up a smart contract, and other transaction data has not been obtained for the predetermined period, the target is regarded as the first target, and transaction data related to the target is deleted.

4. The control method according to claim 1, wherein
when a blockchain wallet having a zero remaining amount of coins is found, the blockchain wallet is regarded as the first target, and transaction data related to the blockchain wallet is deleted.

5. The control method according to claim 1, wherein
a header of metadata and transaction data for a plurality of transactions are stored in each of a plurality of blocks included in the blockchain, the metadata including a hash value of an immediately preceding block and a transaction tree in which the transaction data for the plurality of transactions included in the block is summarized in a Merkle tree, the transaction data for the plurality of transactions being body data,
an account list is further stored in the header, the account list describing monetary transaction information related to an account provided when a blockchain wallet is created, and
when the first target is a first blockchain wallet, the deleting of the transaction data related to the first target includes:
deleting, among transaction data including the first blockchain wallet as a transmission source or a transmission destination, first transaction data including a second blockchain wallet as a transmission source or a transmission destination, the second blockchain wallet being different from the first blockchain wallet and having been deleted; and
deleting information of the first blockchain wallet from one or more account lists describing the information of the first blockchain wallet among a plurality of account lists included in the plurality of blocks.

6. The control method according to claim 5, wherein
a world state indicating a state of an entire network of the blockchain is further stored in an in-memory database of each of the plurality of nodes, and
when the first target is the first blockchain wallet, the control method further comprises:
before the deleting of the transaction data related to the first target, deleting information of the first blockchain wallet that is included in the world state.

7. The control method according to claim 6, wherein
the information of the first blockchain wallet that is included in the world state is information of a sender side and a recipient side that have used the first blockchain wallet.

8. The control method according to claim 1, wherein
the deleting of the transaction data related to the first target includes:
when the first target is a first smart contract, deleting first transaction data for deploying the first smart contract.

9. The control method according to claim 8, wherein
the deleting of the transaction data related to the first target includes:
deleting, together with the first transaction data for deploying the first smart contract, second transaction data for calling up the first smart contract.

10. The control method according to claim 9, wherein
a header of metadata and transaction data for a plurality of transactions are stored in each of a plurality of blocks included in the blockchain, the metadata including a hash value of an immediately preceding block and a transaction tree in which the transaction data for the plurality of transactions included in the block is summarized in a Merkle tree, the transaction data for the plurality of transactions being body data,
an account list is further stored in the header, the account list describing information related to an account address created when the first smart contract is deployed, and
the deleting of the transaction data related to the first target further includes:
deleting information related to the account address from one or more account lists describing the account address among a plurality of account lists included in the plurality of blocks.

11. The control method according to claim 8, wherein
a world state indicating a state of an entire network of the blockchain is further stored in an in-memory database of each of the plurality of nodes, and
the control method further comprises:
before the deleting of the transaction data related to the first target, deleting information of the first smart contract that is included in the world state.

12. A server comprising:
a processor; and
memory, wherein
using the memory, the processor performs the following:
determining presence or absence of transaction data related to a first target that has not been used for a predetermined period among targets each being transaction data stored in a blockchain; and
deleting the transaction data related to the first target from the blockchain based on a determination result indicating that the transaction data related to the first target is present.

13. A recording medium having recorded thereon a program for causing a computer to execute a control method including:
determining presence or absence of transaction data related to a first target that has not been used for a predetermined period among targets each being transaction data stored in a blockchain; and
deleting the transaction data related to the first target from the blockchain based on a determination result indicating that the transaction data related to the first target is present.
